(19) United States
(12) Patent Application Publication
(10) Pub. No.: US 2016/0219373 A1
(43) Pub. Date: Jul. 28, 2016

(54) Piezoelectric Speaker Driver

(71) Applicant: Knowles Electronics, LLC, Itasca, IL (US)

(72) Inventors: Sarmad Qutub, Des Plaines, IL (US); William Ryan, Villa Park, IL (US)

(21) Appl. No.: 15/004,109

(22) Filed: Jan. 22, 2016

Related U.S. Application Data
(60) Provisional application No. 62/107,059, filed on Jan. 23, 2015.

(51) Int. Cl. H04R 17/00; H04R 9/06

(52) U.S. Cl. CPC H04R 17/005; H04R 9/063; H04R 2217/03; H04R 2499/15

(57) ABSTRACT

A speaker apparatus includes a speaker assembly and a piezoelectric driver. The speaker assembly including a diaphragm and a motor. Application of a first electric current to the motor causes a first movement of a portion of the motor. The first movement causes the diaphragm to move and responsively creates sound energy in a first and non-ultrasonic frequency range. The piezoelectric driver is disposed in proximal relation to the speaker assembly. Application of a second electric current to the piezoelectric driver causes actuation of the piezoelectric driver. The actuation is effective to produce an impact of a portion of the piezoelectric driver with the speaker assembly and causes a second movement of the diaphragm within the speaker assembly. The second movement responsively creates sound energy in a second and ultrasonic frequency range.

### CROSS-REFERENCE TO RELATED APPLICATION

This patent claims benefit under 35 U.S.C. §119(e) to U.S. Provisional Application No. 62/107,059 entitled “Piezoelectric Speaker Driver” filed Jan. 23, 2015, the content of which is incorporated herein by reference in its entirety.

### TECHNICAL FIELD

This application relates to speakers and, more specifically, to driving speakers.

### BACKGROUND OF THE INVENTION

Different types of acoustic devices have been used through the years. One type of acoustic device is a speaker or receiver. Generally speaking, a speaker or receiver converts an electrical signal into sound energy. These devices may be used in hearing instruments such as hearing aids or in other electronic devices such as cellular phones and computers.

One type of speaker typically includes a coil, a yoke, an armature (or reed), and magnets. An electrical signal applied to the coil and creates a magnetic field within the motor which causes the armature to move. Movement of the armature causes movement of a diaphragm, which creates sound. Together, the magnets, armature, and yoke form a magnetic circuit. The yoke may also serve to hold or support the magnets or other components.

Another type of speaker (dynamic) includes a coil and a diaphragm, which are coupled together. This type of speaker also has fixed magnets. Excitation of the coil creates a magnetic field which, with the presence of the magnets, causes the coil to move. The coil moves the diaphragm and coil in unison (mimicking the action of a moving piston), causing sound to be produced.

Unfortunately, previous approaches have performance limitations. More specifically, previous speakers had difficulty in providing adequate performance in ultrasonic frequency ranges. These problems have limited the usability of speakers and have resulted in some user dissatisfaction.

### BRIEF DESCRIPTION OF THE DRAWINGS

For a more complete understanding of the disclosure, reference should be made to the following detailed description and accompanying drawings wherein:

FIGS. 1A and 1B comprise block diagrams of a system including speaker that is driven by a piezoelectric driver according to various embodiments of the present invention;

FIG. 2 comprises a perspective view of the speaker of FIGS. 1A and 1B with the top plate exploded according to various embodiments of the present invention;

FIG. 3 comprises a perspective, exploded view of the speaker of FIGS. 1-2 according to various embodiments of the present invention;

FIG. 4 comprises an exploded cross section view of the speaker of FIGS. 1-3 according to various embodiments of the present invention;

FIG. 5 comprises a cross section view of the speaker of FIGS. 1-4 according to various embodiments of the present invention;

FIG. 6 comprises a top view of the speaker of FIGS. 1-5 without the cover according to various embodiments of the present invention;

FIG. 7 comprises a top view of the speaker of FIGS. 1-6 with the cover according to various embodiments of the present invention;

FIG. 8 comprises a side cross sectional view of a diaphragm of the speaker of FIGS. 1-7 with the cover according to various embodiments of the present invention;

FIG. 9 comprises a side view of a piezoelectric driver according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

In the approaches presented herein, a piezoelectric driver is placed in close proximity to a speaker. In one example, the piezoelectric driver is disposed underneath the speaker and touches the speaker. The piezoelectric driver is actuated and used to drive the speaker in a frequency range where higher acoustic output is desired, complementing the speaker's intrinsic acoustic response. The frequency range may be in the audible band (approximately 20 Hz to 20 kHz) or in the ultrasonic frequency range (greater than 20 kHz). As the piezoelectric driver moves or bends, such movement or bending causes the speaker to move thereby creating sound energy in the target frequency range. The speaker is driven using separate leads for other normal audio frequencies.

The piezoelectric structure or driver, in one aspect, may include a first metal layer, a piezoelectric layer (e.g., a crystalline layer), and a second metal layer. As mentioned, the piezoelectric structure moves upon application of electric current (representing a desired signal) causing movement of the speaker, which in turn moves the speaker thereby causing the speaker to produce sounds in the audible or ultrasonic frequency range. In other words, these approaches enhance specific target frequencies of the speaker's acoustic response or extend the bandwidth of the speaker to frequencies that may be in the audible or ultrasonic frequency range when the piezoelectric structure is excited thereby producing an enhanced signal. The piezoelectric driver may include a crystalline structure, lead zirconate titanate (PZT), or barium titanate to mention a few examples. Other examples of materials are possible. In some aspects, the piezoelectric material exhibits motion when an electric field is applied.

The present approaches improve current receivers (speakers) that are used for proximity detection because these receivers can be designed to have a resonant peak in the ultrasonic band. Additionally, the entire surface area of the speaker is used to generate the ultrasonic signal, thereby increasing the range of possible applications that can be enabled. Further and advantageously, the present approaches can be used with any speaker or receiver. The present approaches also improve the acoustic response of current receivers (speakers) by enhancing targeted frequencies in the audible range.

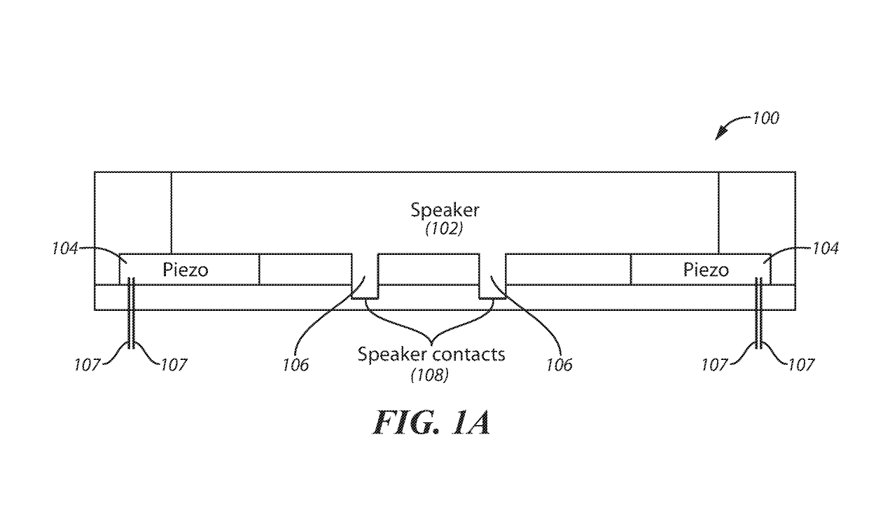

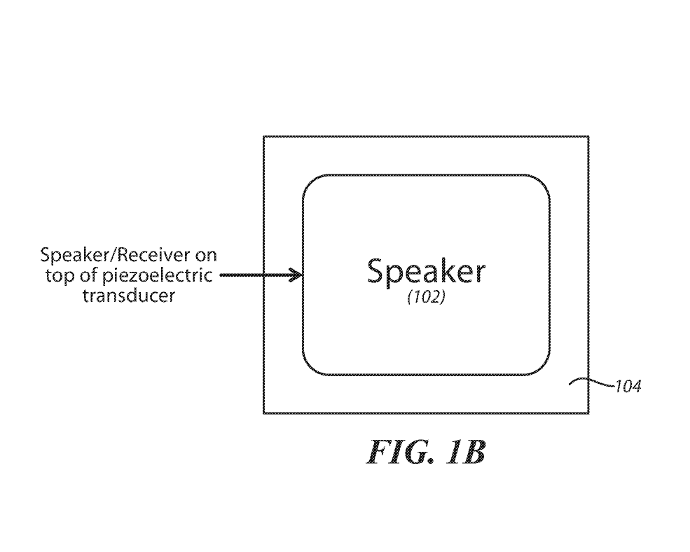

Referring now to FIG. 1A-B, one example of a speaker assembly 100 used with a piezoelectric transducer is described. The assembly 100 includes a speaker 102 and piezoelectric drivers 104. Leads 107 drive the piezoelectric driver 104 and leads 106 drive the speaker. As electrical current is applied to the piezoelectric driver 104, the piezoelectric driver 104 moves or bends. This movement causes the speaker 102 to move. The speaker 102 includes a diaphragm. The movement of the speaker 102 moves the diaphragm (or membrane) within the speaker to create sound in the targeted frequency range, which may be in the audible or ultrasonic frequency range. Electrical signals representing sound in the normal audio range are applied to the speaker 102 via the leads 106 and contacts 108. Application of electrical current to leads 106 causes the speaker 102 to produce sound energy in the normal audio operating range.

It will be understood that the approaches described herein operate with audible signals in the approximately 20 Hz-20 kHz range (referred to herein is the normal audio operating range). It will also be understood that the approaches described herein operate with inaudible ultrasonic signals beyond the human audible range of approximately 20 kHz range. Such signals may be any signal that is inaudible to human beings which, while most are above 20 kHz, can be below 20 kHz (these are referred to as the ultrasonic operating range).

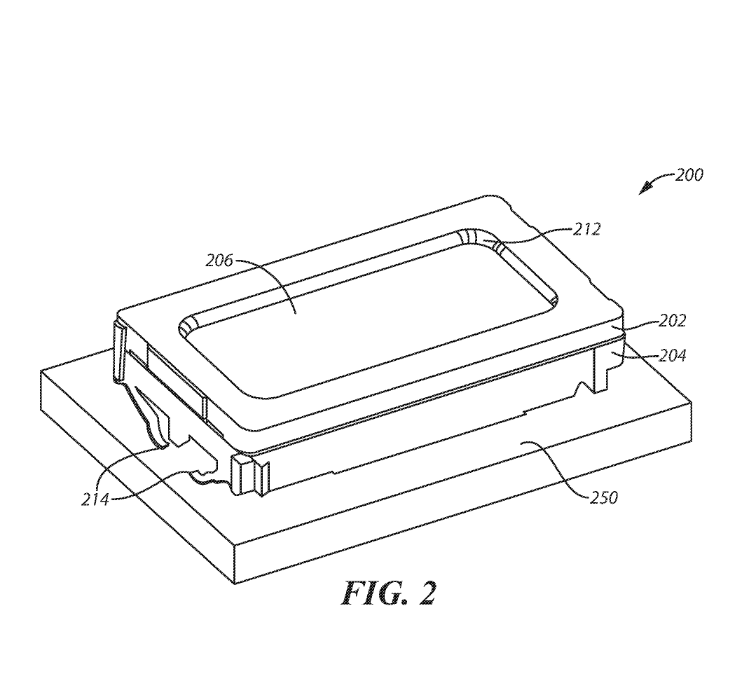

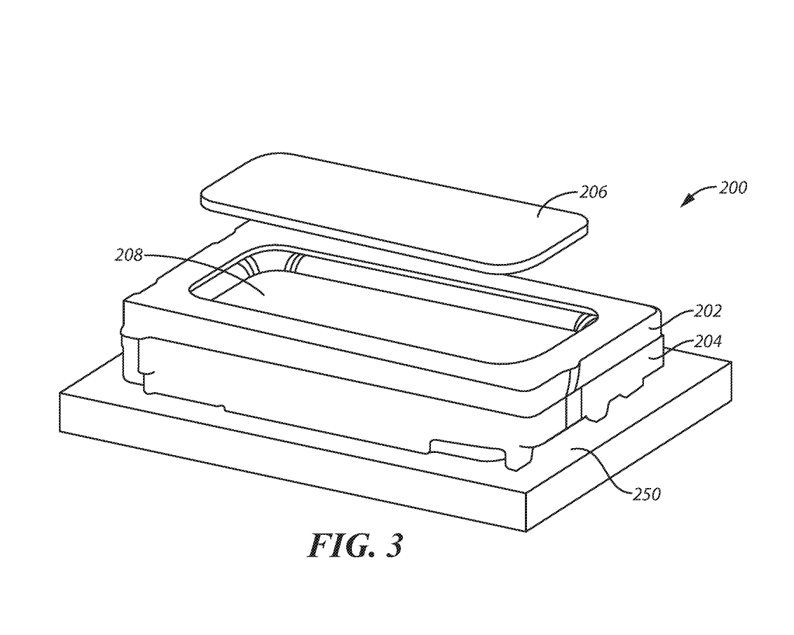

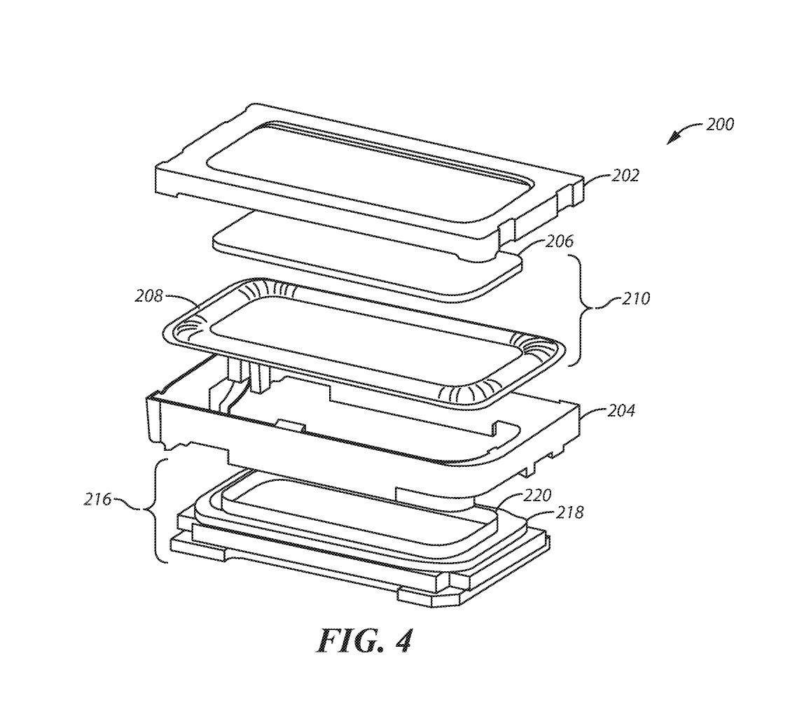

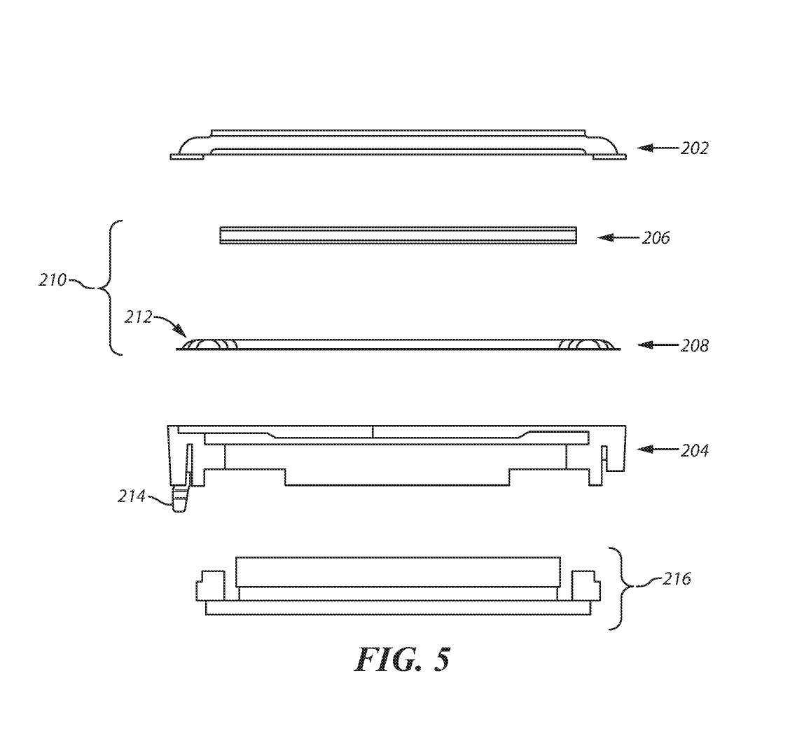

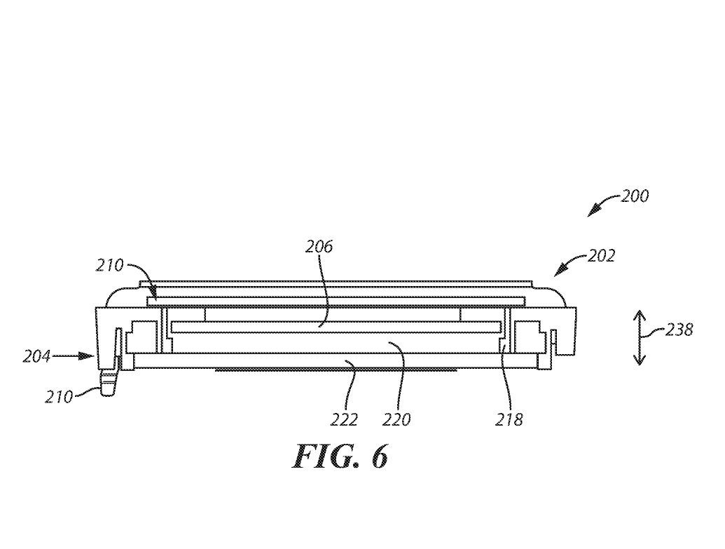

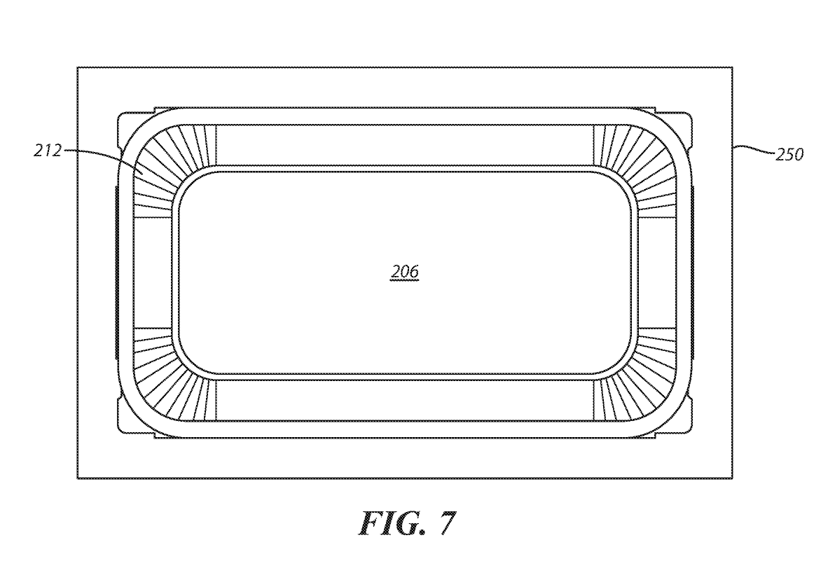

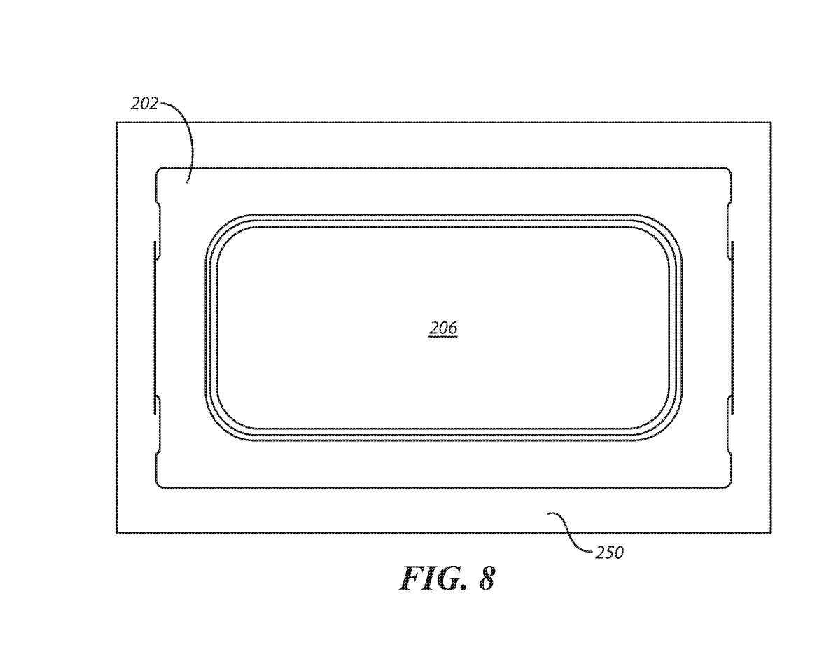

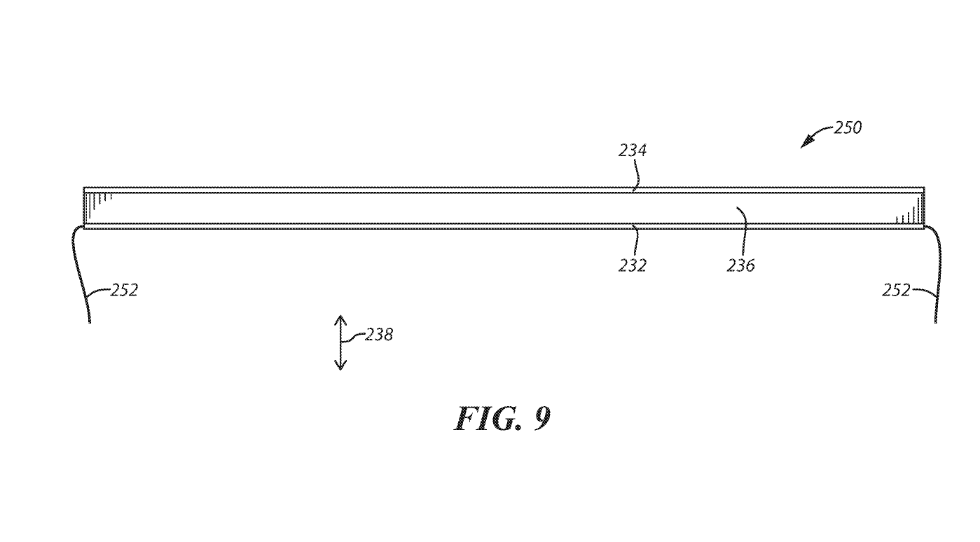

Referring now to FIGS. 2-9, an example of a speaker arrangement 200 is described. The speaker 200 includes a top speaker casing (or cover) 202, a bottom speaker casing (or basket, or support structure) 204, a diaphragm assembly 210 (a membrane 208, and annulus 212), contacts 214, and an acoustic motor 216 (including a coil 218, a center magnet 220, a pot 222).

The top speaker casing or cover 202 attaches to the bottom speaker casing or basket 204. The top speaker casing 202 and the bottom speaker casing 204 may be constructed of any suitable material such as plastic. Together, casings 202 and 204 enclose, hold, and secure the interior elements of the speaker 200.

The membrane 208 may be constructed of any flexible material. The annulus 212 is a flexible material in the opening between in proximity to the speaker casing 204. The purpose of the annulus 212 is to provide compliance for the movement of the membrane and stiffening plate structure and ensure all motion during transduction is in the vertical axis 238. It will be understood that some speakers may not have membranes.

Electrical contacts 214 provide electrical connections to another device (e.g., an electronic component in a consumer device, or an amplifier to mention two examples). In one aspect, the other device provides an electric signal representative of sound energy. These electrical signals applied to the speaker 202 create sound energy in the normal audio operating range.

As mentioned, the acoustic motor 216 includes the coil 218, center magnet 220, and pot 222. Current supplied by the contacts 214 flows through the coil 218. The coil extends around a periphery of the center magnet 220. The pot 222 creates a path for the static magnetic field. As the current flows, a changing magnetic field is created within the motor and this moves the diaphragm assembly.

As mentioned, the diaphragm assembly may also include the stiffening plate 206 that acts as a stiffener to the diaphragm. Examples of materials that can be used include ceramic, metallic, or piezoelectric. Other examples are possible.

A piezoelectric structure 250 is disposed below (or otherwise in close proximity to the speaker 200) so that movement (or bending) of the piezoelectric structure can be communicated or transferred to the speaker 202. The piezoelectric structure 250 includes a first metal layer 232, second metal layer 234, and piezoelectric layer 236. The metal layers 232 and 234 can be constructed of any suitable metal such as copper. The piezoelectric layer 236 exhibits stress when an electric field is applied. The material used to construct the piezoelectric layer 236 may have a crystalline structure, and may be PZT, or barium titanate to mention a few examples. Other examples of materials are possible.

Electric leads 252 are coupled to the piezoelectric structure 250. The leads 252 supply a signal that represents ultrasonic sound energy. The piezoelectric structure may be shaped in a convenient manner (e.g., as a solid square or rectangle, or as a ring-shaped element).

It will be understood that the speaker 202 may be disposed in some other structure such as in a consumer electronic device (e.g., cellular phone, personal computer, laptop computer, or tablet). Features, elements, or components of this other structure together with the speaker may create a front volume and a back volume, in which the diaphragm assembly moves and creates sound. The sound so-created may exit the front volume by a sound tube or channel so that the sound can be presented to a user for listening.

In one example of the operation of the system of FIGS. 2-9, current (representing sound energy in the normal audio range) is applied to the coil 218 via the contacts 214, and this together with the operation of the magnet 220 creates a magnetic field in the motor 216. Responsively, the diaphragm assembly 210 (including the plate 206 and the membrane 208) moves up and down in the direction indicated by the arrow labeled 238. This action creates sound (in the normal audio range) in the front volume that exits the sound tube or some other suitable element.

Electrical signals representing the targeted frequency range, which may be in the audible or ultrasonic frequency range are applied to the piezoelectric structure 250. The piezoelectric structure 250 moves or bends, which moves the speaker 102. Responsively, the speaker assembly 102 moves up and down also in the direction indicated by the arrow labeled 238. This action creates sound in the front volume that exits the sound tube or some other suitable element, but this sound is in the targeted frequency range, which may be in the audible or ultrasonic frequency range since the movement that created the sound originates with the piezoelectric structure 250.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A speaker apparatus, comprising,
a speaker assembly, the speaker assembly including a diaphragm and a motor, wherein application of a first electric current to the motor causes a first movement of a portion of the motor, the first movement causing the diaphragm to move and responsively create sound energy in a first and non-ultrasonic frequency range;
a piezoelectric driver that is disposed in proximal relation to the speaker assembly, wherein application of a second electric current to the piezoelectric driver causes actuation of the piezoelectric driver, the actuation being effective to produce an impact of a portion of the piezoelectric driver with the speaker assembly and cause a second movement of the diaphragm within the speaker assembly, the second movement responsively creating sound energy in a second and ultrasonic frequency range.

2. The speaker apparatus of claim 1, wherein the piezoelectric driver includes a first metal layer, a piezoelectric layer, and a second metal layer.

3. The speaker apparatus of claim 2, wherein the piezoelectric layer is formed of a crystalline structure.

4. The speaker apparatus of claim 1, wherein the speaker assembly includes a magnet coil assembly that is disposed on and actuated by two or more piezoelectric components in the same assembly.

5. The speaker apparatus of claim 1, wherein the speaker assembly includes a magnetic coil assembly and entire magnet coil assembly is disposed on a single piezoelectric component.

6. The speaker apparatus of claim 1, wherein the motor includes a coil, center magnet and pot.

7. The speaker apparatus of claim 6, wherein the coil extends around a periphery of the center magnet.

8. The speaker apparatus of claim 1, wherein the diaphragm includes a stiffening plate.

9. The speaker apparatus of claim 1, wherein the speaker apparatus is disposed in a cellular phone, a personal computer, a laptop computer, or a tablet.

10. A method of operating a speaker apparatus, the speaker apparatus including a speaker assembly and a piezoelectric driver that is disposed in proximal relation to the speaker assembly, the speaker assembly including a diaphragm and a motor, the method comprising,
applying a first electric current to the motor causing a first movement of a portion of the motor, the first movement causing the diaphragm to move and to produce sound energy in a first and non-ultrasonic frequency range;
applying a second electric current to the piezoelectric driver causing actuation of the piezoelectric driver, the actuation operable to cause an impact of at least a portion of the piezoelectric driver with the speaker assembly responsively producing a second movement of the diaphragm within the speaker assembly to create sound energy in a second and ultrasonic frequency range.

11. The method of claim 10, wherein the piezoelectric driver includes a first metal layer, a piezoelectric layer, and a second metal layer.

12. The method of claim 11, wherein the piezoelectric layer is formed of a crystalline structure.

13. The method of claim 10, wherein the speaker assembly includes a magnet coil assembly that is disposed on and actuated by two or more piezoelectric components in the same assembly.

14. The method of claim 10, wherein the speaker assembly includes a magnetic coil assembly and entire magnet coil assembly is disposed on a single piezoelectric component.

15. The method of claim 10, wherein the motor includes a coil, center magnet and pot.

16. The method of claim 15, wherein coil extends around a periphery of the center magnet.

17. The method of claim 10, further comprising disposing a stiffening plate at the diaphragm.

18. The method of claim 10, further comprising disposing the speaker apparatus in a cellular phone, a personal computer, a laptop computer, or a tablet.
